(19) United States
(12) Patent Application Publication
(10) Pub. No.: US 2004/0123325 A1
(43) Pub. Date: Jun. 24, 2004

(54) Technique for delivering entertainment and on-demand tutorial information through a communications network

(76) Inventors: Charles W. Ellis, Fairfield, CT (US); Michael L. Lajoie, Stamford, CT (US); Julie Simon Knight, New York, NY (US)

Correspondence Address: Alex L. Yip, Kaye Scholer LLP, 425 Park Avenue, New York, NY, 10022, US

(21) Appl. No.: 10/328,297

(22) Filed: Dec. 23, 2002

(51) Int. Cl. H04N 7/173

(52) U.S. Cl. 725/91; 725/87; 725/88; 725/94

(57) ABSTRACT

Tutorial information is provided on an on-demand basis over a digital two-way multichannel broadband communications network, e.g., cable TV network, which is also used for transmission of entertainment programming content. The tutorial information may relate to the access, control and viewing of the programming content. In an illustrative embodiment of the invention, in response to a request for tutorial information initiated by a user, a graphical user interface (GUI) is provided, which lists tutorial topics for user selection. Upon a selection of a tutorial topic, the related tutorial presentation is transmitted to the user, which may be in the form of a video presentation, slideshow presentation and/or textual displays. The tutorial presentation may be manipulated by the user to perform rewinding, pausing and fast-forwarding thereon.

### FIELD OF THE INVENTION

The invention relates to communications systems and methods, and more particularly to a system and method for delivering information and entertainment programs through a communications network, e.g., a cable network.

### BACKGROUND OF THE INVENTION

Broadcast of entertainment programming content, e.g., TV programs, over broadband communications networks, such as cable networks, is well known. As a matter of fact, the amount of programming content delivered over such networks is ever increasing. At the same time, the number and types of cable service features introduced to enhance a user's program enjoyment are ever growing. The array of such features has become diverse in nature, and in some instances complex.

For example, some cable operators provide a user with the capability of limiting the type of programming content that may be viewed by others at the user's set-top box. To that end, the user is afforded a “parental control” option or some other content blocking option. Another service feature enables a user to access programming content on an on-demand basis, e.g., a video-on-demand (VOD) service feature, thereby freeing the user from the traditional constraint of a broadcast schedule. In addition, the user is allowed to manipulate a VOD presentation by performing such functions as rewinding, pausing, and fast-forwarding thereon. Yet another feature enables a user to use a cable modem to access information from the Internet through the same cable network for transmission of programming content, although the Internet information delivery and programming content transmission utilize different frequency bands of a forward passband of the cable network.

### SUMMARY OF THE INVENTION

Due to provisioning of an increasing number of cable service features at a rapid rate, cable users are frequently unaware of the availability of many of these offerings. In addition, in some instances, because of the complexity of some of these features (e.g., the steps involved to access such features), users at times may give up on utilizing them, which is unfortunate.

The invention overcomes the prior art limitations by providing tutorial information relating to service features on an on-demand basis. In accordance with the invention, after a request for tutorial information is received from a user terminal through a two-way multichannel delivery network, e.g., cable TV delivery network, a data stream containing selected tutorial information is transmitted through the network in response to the request. The selected tutorial information includes selectable options for tutorial presentations relating to different service features available through the network. The data stream is identified by an identifier, which is communicated to the user terminal for receiving the data stream.

Thus, with the invention, after a user goes through a tutorial presentation, the user becomes familiar with the related service feature and its implementation, thereby facilitating the utilization of the service feature.

### BRIEF DESCRIPTION OF THE DRAWING

Further objects, features and advantages of the invention will become apparent from the following detailed description taken in conjunction with the accompanying drawings showing illustrative embodiments of the invention, in which:

FIG. 1 is a block diagram of a broadband communications system in accordance with the invention;

FIG. 2 illustrates selected carriers for transmitting program and tutorial materials in a forward passband of the system of FIG. 1;

FIG. 3 illustrates a graphical user interface (GUI) for accessing “Digital Cable” service related tutorials in accordance with an embodiment of the invention;

FIG. 4 illustrates a script of a video presentation of one of the tutorials;

FIG. 5 illustrates a GUI for accessing “On Demand” service related tutorials in accordance with an embodiment of the invention;

FIG. 6 illustrates a GUI for accessing “Digital Video Recorder (DVR)” service related tutorials in accordance with an embodiment of the invention;

FIG. 7 illustrates a GUI for accessing “High Speed Internet” service related tutorials in accordance with an embodiment of the invention; and

FIG. 8 illustrates a GUI for accessing “High Definition TV (HDTV)” service related tutorials in accordance with an embodiment of the invention.

### DETAILED DESCRIPTION

The invention is directed to providing tutorial information respecting the access, control and viewing of programming content and information over a digital two-way multichannel broadband communications network, such as a cable TV network. It will be appreciated that the invention may also be deployed in other communications systems, such as a direct broadcast satellite (DBS) system especially when its two-way communications capability is realizable. In an illustrative embodiment of the invention, tutorial presentations may be accessed by a user on an on-demand basis with the aid of graphical user interfaces (GUIs), referred to as “Answers On-Demand (AOD) GUIs.” A tutorial presentation comprises instructional information for assisting the user to learn about and implement different service features made available through the cable network. For example, the AOD GUIs may include topics relating to using a remote control to access information and programming content, exercising a “parental control” option or some other control to block certain content from being displayed, accessing on-demand services (e.g., movies-on-demand (MOD) and subscription video-on-demand (SVOD)), recording programming content, accessing high speed Internet, exercising home networking options, changing PINs, implementing set-top private video recorder (PVR) functions, etc. The AOD GUIs allow a user to selectively access a tutorial presentation in an interactive and user-friendly manner. The tutorial presentation may comprise a video presentation, slideshow presentation and/or textual displays. Like a prior art VOD presentation, the tutorial presentation here may be manipulated to perform rewinding, pausing and fast-forwarding thereon.

A user may access AOD GUIs by tuning to a dedicated program channel for carrying tutorial information. In another instance, a user while viewing a selected program channel, e.g., an MOD channel, may access one or more AOD GUIs relating to the MOD application by selecting an AOD displayed option, which may involve pressing a designated key, e.g., “INFO” key, on a remote control.

FIG. 1 illustrates broadband communications system 100 embodying the principles of the invention for providing information, e.g., the tutorial information, and programming content to set-top terminals on users' premises. As shown in FIG. 1, system 100 includes headend 110, hub 120, hybrid fiber coaxial (HFC) cable network 140, and service area node 150 which is connected to set-top terminals 158-1 through 158-L in a neighborhood, where L is a predetermined number.

Broadcast subsystem 112 receives programming content from various providers and sources, e.g., analog and digital satellite sources, application servers, media servers, etc. In a conventional manner, the received composite program stream is processed by subsystem 112, resulting in transport streams. The resulting transport streams are switched by switching unit 114 to appropriate modulators in hub 120 to broadcast the programming content to users through HFC cable network 140.

Tutorial information (including, e.g., AOD GUI information describing the available tutorials as well as the content of the actual tutorials) is stored in tutorial storage 116, which may be encoded in an MPEG-2 format. As mentioned before, the tutorial content is accessible with the aid of AOD GUIs described below.

Upon a user request, tutorial information is served to a user by tutorial server 118 which includes such conventional VOD server functions as accessing tutorial storage 116 to provide a data stream containing the tutorial information for transmission to the user. In this instance, the data stream is transmitted through a transmission channel having a specified frequency band. It should be noted that the term “transmission channel” should not be confused with a “program channel.” A “transmission channel” signifies a designated frequency band through which a data stream is transmitted. On the other hand, a “program channel” signifies the source of the program material selected by a user to view. For example, a user may select program channel 2 to view program material provided by CBS, program channel 14 to view program material provided by ESPN; program channel 32 to view program material provided by MTV, etc. In this illustrative embodiment, the transmission channels may be 6 MHz bands populating a forward passband, e.g., 350-750 MHz band, of a coaxial cable, which is allocated for downstream communication from headend 110 to a set-top terminal.

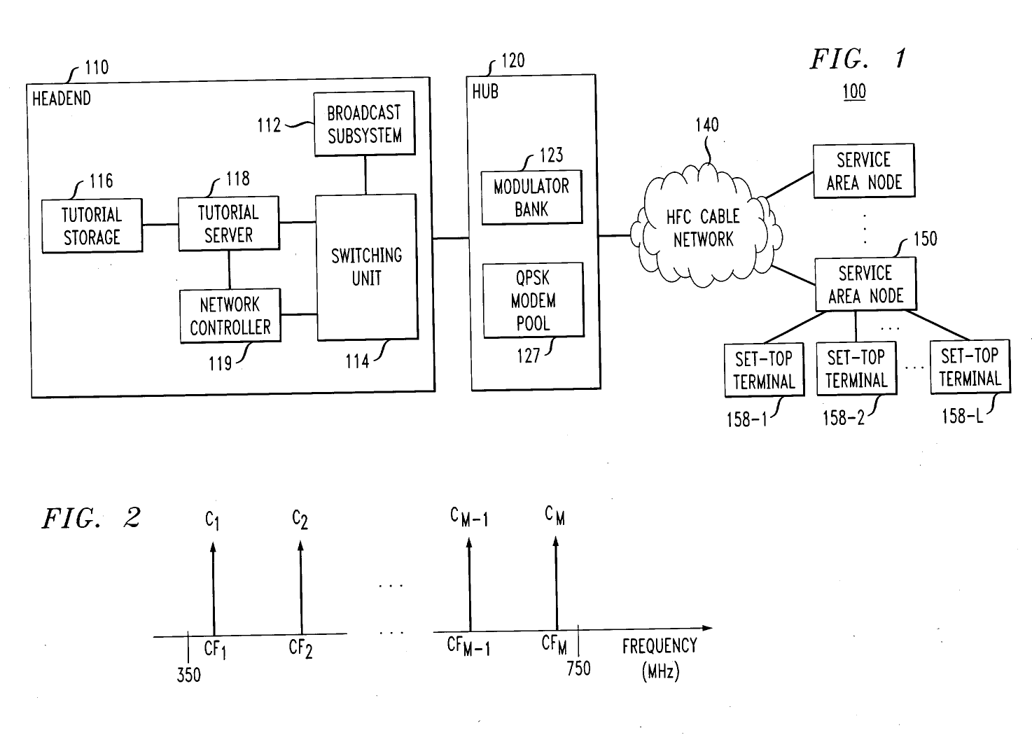

Modulator bank 123 in this instance is located in hub 120 connected to headend 105 via IP transport on the one hand and to HFC cable network 140 on the other hand. Bank 123 includes multiple modulators, each of which is used to modulate transport streams onto different carriers. Each modulated carrier carrying a transport stream is transmitted through a transmission channel associated therewith. FIG. 2 illustrates M carriers, C₁ through C_{M}, associated with M transmission channels in the forward passband. As shown in FIG. 2, the carrier frequency of C₁ is denoted CF₁; the carrier frequency of C₂ is denoted CF₂; . . . ; and the carrier frequency of C_{M} is denoted CF_{M}. In this example, each data stream may contain 4.2 Mb/s video and audio tutorial information. By using a 256-quadrature-amplitude-modulation (256-QAM) technique and 6 MHz transmission channel, each modulator in modulator bank 123 in this instance may modulate up to 9 data streams, multiplexed in a transport stream, onto the corresponding carrier. The resulting modulated carrier is transmitted through the transmission channel associated with the carrier.

Upstream data from a set-top terminal to headend 110 is communicated via a reverse passband, e.g., 5-40 MHz band, of a coaxial cable. The reverse passband comprises reverse data channels (RDCs) having a 1 MHz bandwidth in this instance, through which quaternary phase shift keying (QPSK) signals containing upstream data are transmitted. It should be noted that the 1 MHz bandwidth allocated for an RDC here is for illustrative purposes only. Downstream data from headend 110 to a set-top terminal is communicated via forward data channels (FDCs). These channels, often referred to as “out-of-band” channels, may occupy the 70-130 MHz band of a coaxial cable. QPSK signals containing system messages to a set-top terminal are transmitted through an FDC having a 1 MHz bandwidth in this instance. It should be noted that the 1 MHz bandwidth allocated for an FDC here is for illustrative purposes only.

In this instance, network controller 119 in headend 110 may receive a request for tutorial information from, say, set-top terminal 158-1. Such a request may be initiated by a user in various ways. For example, the request may be initiated when a user accesses a pre-designated program channel (e.g., program channel 1) that is dedicated to providing tutorial information. In another instance, the request may be initiated when a user while viewing certain program channels, e.g., an MOD channel, selects a displayed AOD option relating to the MOD application. In either instance, terminal 158-1 formats the request and transmits the resulting request, including a network address of terminal 158-1 (e.g., an IP address or MAC address), to headend 110 through a RDC.

Upon receiving the request for tutorial information, network controller 119 in a conventional manner identifies a carrier, say C₁, for carrying a transport stream destined for the neighborhood of terminal 158-1. It should be noted that each carrier in system 100 is associated with a different one of the transmission channels in the forward passband. In addition, each transport stream is identified by a different transport stream identification (TSID) in system 100. Controller 119 causes tutorial server 118 to access tutorial storage 116 for tutorial information including, e.g., an AOD GUI, and generate a data stream containing the tutorial information. Such a data stream, identifiable by a program ID (PID), may be multiplexed with other data streams in the transport stream. Server 118 causes switching unit 114 to switch the transport stream to an appropriate modulator in modulator bank 123 where the transport stream is modulated onto the identified carrier, i.e., C₁ in this instance. The modulated carrier traverses the transmission channel associated therewith in HFC cable network 140.

In response to the received request, network controller 119 communicates to terminal 158-1 via an FDC a message concerning the carrier frequency to which terminal 158-1 should tune to receive the appropriate transport stream, and the PID for extracting the desired data stream identified thereby from the transport stream. Accordingly, relying on the information in such a message, terminal 158-1 obtains the desired data stream. In a well known manner, terminal 158-1 converts the data stream to appropriate signals for the associated TV to display the tutorial information including, e.g., an AOD GUI.

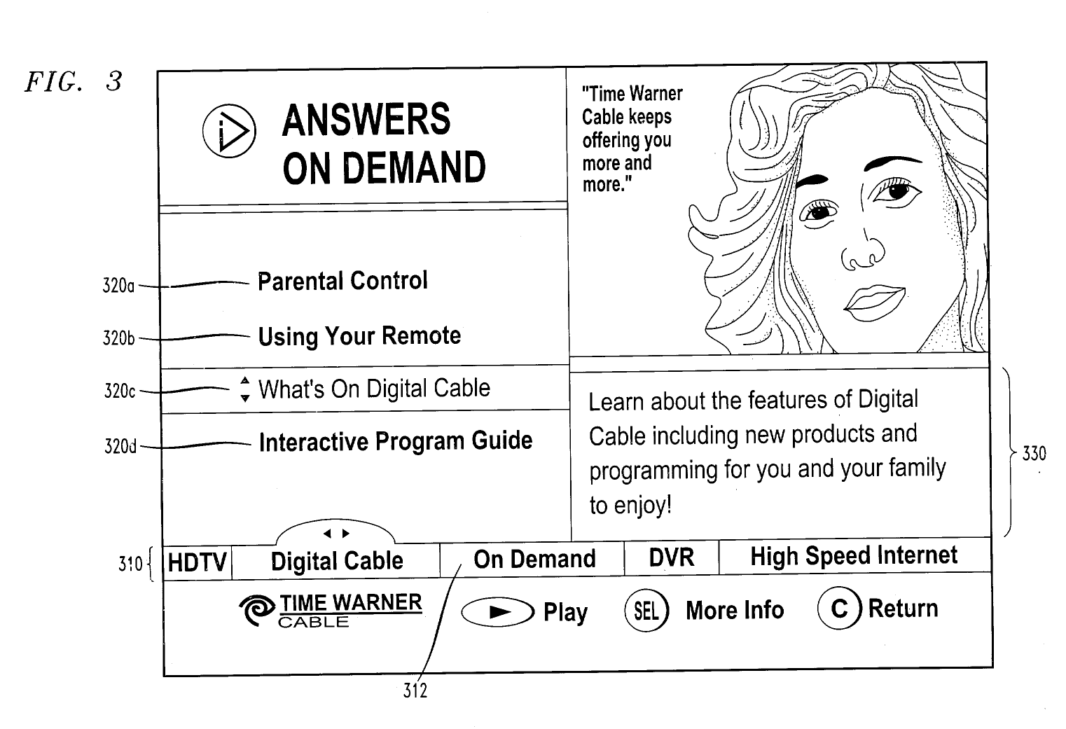

FIG. 3 illustrates one such AOD GUI, referred to as a “Digital Cable GUI,” for obtaining tutorial presentations relating to accessing digital cable programming content made available by headend 110. As shown in FIG. 3, the Digital Cable GUI in this instance provides topical options including Parental Control option 320a, Using Your Remote option 320b, What's On Digital Cable option 320c and Interactive Program Guide option 320d. The user may use navigation keys (e.g., up and down navigation keys) on the remote control associated with terminal 158-1 to access and highlight one of the options before it is selected. In this instance, the user highlights What's on Digital Cable option 320c. In response, a description, denoted 330, describing the highlighted topic is provided—“Learn about the features of Digital Cable including new products and programming for you and your family to enjoy!” Upon learning the description of the highlighted topic, the user may decide to select option 320c to access a tutorial presentation having such a topic. The selection may be accomplished by pressing a “Select” key on the user's remote control. The tutorial presentation may be in the form of a video presentation, slideshow presentation and/or textual displays. Thus, description 330 advantageously serves as a preview of the tutorial presentation to be selected.

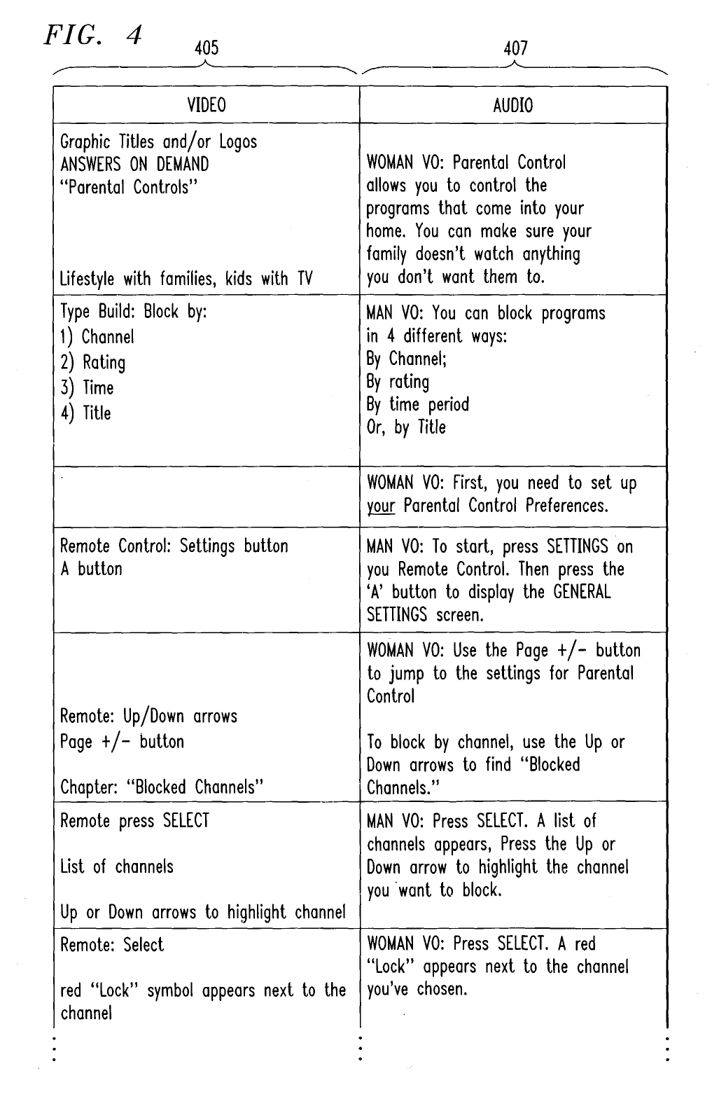

In addition, in this instance a selection of Parental Control option 320a causes a provision of a tutorial presentation relating to the functionality of blocking certain types of programming for selected viewers at the user's set-top terminal. FIG. 4 illustrates a script of such a tutorial presentation in the form of a video presentation. As shown in FIG. 4, the script comprises video component 405 and audio component 407 whose contents are self-explanatory. In the tutorial presentation, in accordance with an aspect of the invention, the user is afforded a selectable service access option (not shown), e.g., an hyperlink, for accessing the underlying service feature, e.g., the Parental Control service feature in this instance. Advantageously, with such an option, a user may choose to access and implement the service feature immediately after the user learns about its implementation.

Further, a selection of Using Your Remote option 320b causes a provision of a tutorial presentation relating to the features of the remote control associated with the user's set-top terminal. A selection of Interactive Programming Guide option 320d causes a provision of a tutorial presentation relating to use of a programming guide and accessing listed programs through such a guide.

It should be noted that, besides playing or terminating the presentation of a tutorial, the tutorial presentation may be manipulated to perform rewinding, pausing and fast-forwarding thereon. This is accomplished by the conventional VOD functions incorporated in server 118 responsive to various manipulation commands, which may be initiated by the user's pressing the corresponding keys on the remote control. VOD servers are commercially available from companies including Seachange International, nCUBE Corp. and Concurrent Computer Corp.

In addition, a user may issue a command to download tutorial content to a video recording device (e.g., VCR, PVR or digital video recorder (DVR)) connected to the user's set-top terminal. The tutorial content may also be displayed on the associated TV in textual or slideshow format, and printed using a printer connected to the user's set-top terminal.

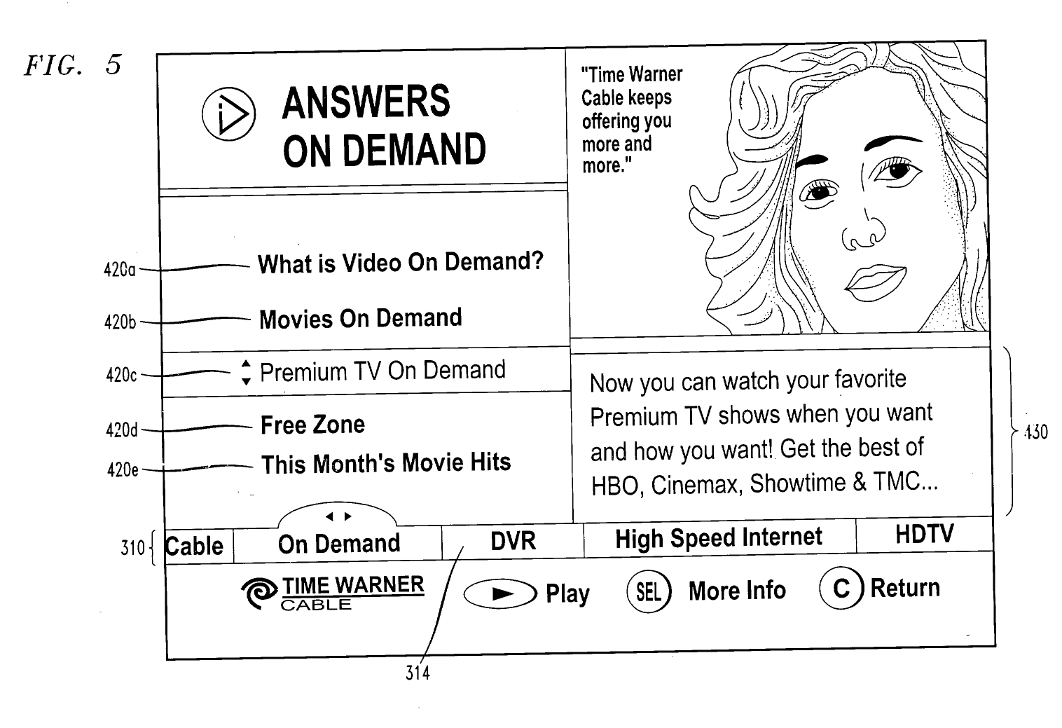

The Digital Cable GUI in this instance also provides a service menu, denoted 310. By selecting, say, “On Demand” menu item 312, the user is provided with another AOD GUI, referred to as an “On Demand GUI.” The selection of a desired menu item may be accomplished by using navigation keys (e.g., left and right navigation keys) on the remote control to access the desired item, followed by a depression of the “Select” key. FIG. 5 illustrates the On Demand GUI which relates to different on-demand features offered by a VOD server (not shown) in system 100.

As shown in FIG. 5, the On Demand GUI provides topical options for which tutorial presentations are available. These topical options may include: What is Video On Demand option 420a, Movies On Demand option 420b, Premium TV On Demand option 420c, Free Zone option 420d, and This Month's Movie Hits option 420e. In this instance, option 420c is highlighted, thereby providing a preview description (denoted 430) of a tutorial presentation having the highlighted topic—“Now you can watch your favorite Premium TV shows when you want and how you want! . . . ” Upon learning description 430, the user may decide whether to select option 420c to obtain the related tutorial presentation.

In addition, in this instance a selection of What Is Video On Demand option 420a causes a provision of a tutorial presentation relating to accessing videos with no schedule constraint, the manner in which such feature may be accessed by a user, and the manner of identifying the types of programs (movies, shows, etc.) and specific program titles that are available on-demand. A selection of Movies On Demand option 420b causes a provision of a tutorial presentation relating to accessing movies at the user's convenience, the manner in which such feature may be accessed by a user, and the procedure for identifying the movie titles that are available on-demand. A selection of Free Zone option 420d causes a provision of a tutorial presentation relating to accessing programming content on-demand which, perhaps for promotional purposes, is offered for free, but otherwise on a premium program channel requiring a subscription fee. A selection of This Month's Movie Hits option 420e causes a provision of a tutorial presentation relating to accessing a listing of popular or recommended programming that is available to a user on-demand, as well as the manner for accessing the listed programs.

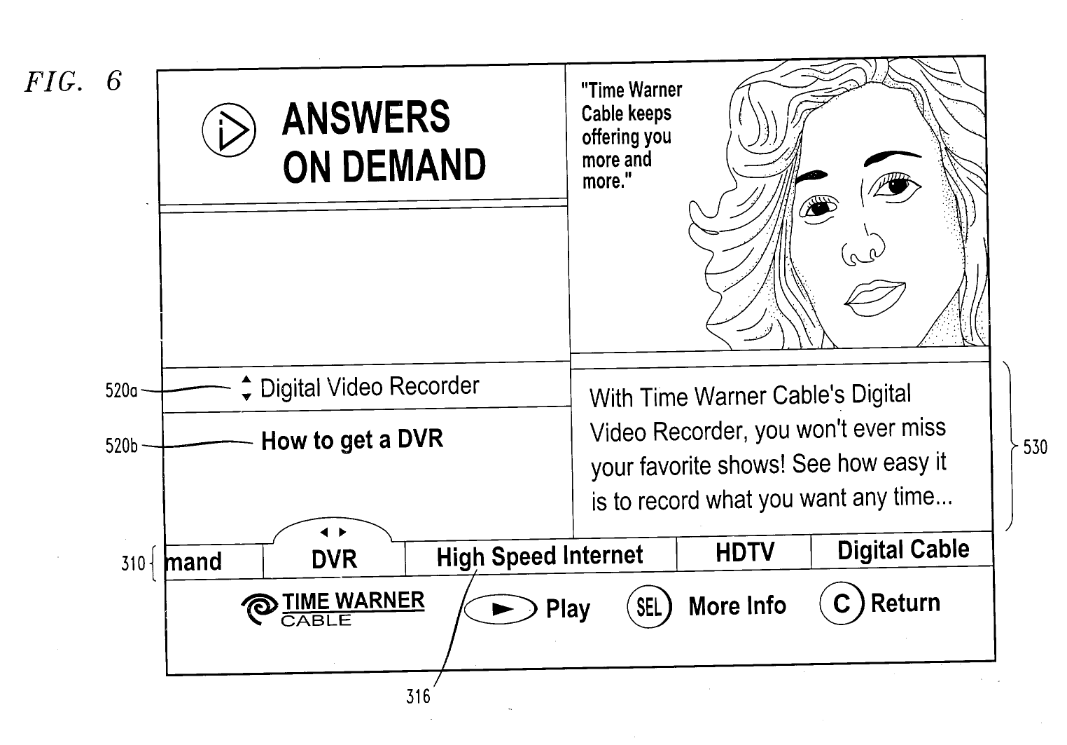

By selecting, say, “DVR” menu item 314 on service menu 310, the user is provided with another AOD GUI, which is illustrated in FIG. 6. This AOD GUI, referred to as a “DVR GUI,” relates to digital video recorder functions for recording broadcast programming content for subsequent viewing.

As shown in FIG. 6, the DVR GUI provides topical options for which tutorial presentations are available. These topical options may include: Digital Video Recorder option 520a and How to Get a DVR option 520b. In this instance, option 520a is highlighted, thereby providing a preview description (denoted 530) of a tutorial presentation having the highlighted topic—“With Time Warner Cable's Digital Video Recorder, you won't ever miss you favorite shows! . . . ” Upon learning description 530, the user may decide whether to select option 520a to obtain the related tutorial presentation.

In addition, in this instance a selection of How to Get a DVR option 520b causes a provision of a tutorial presentation relating to the process for acquiring one such DVR.

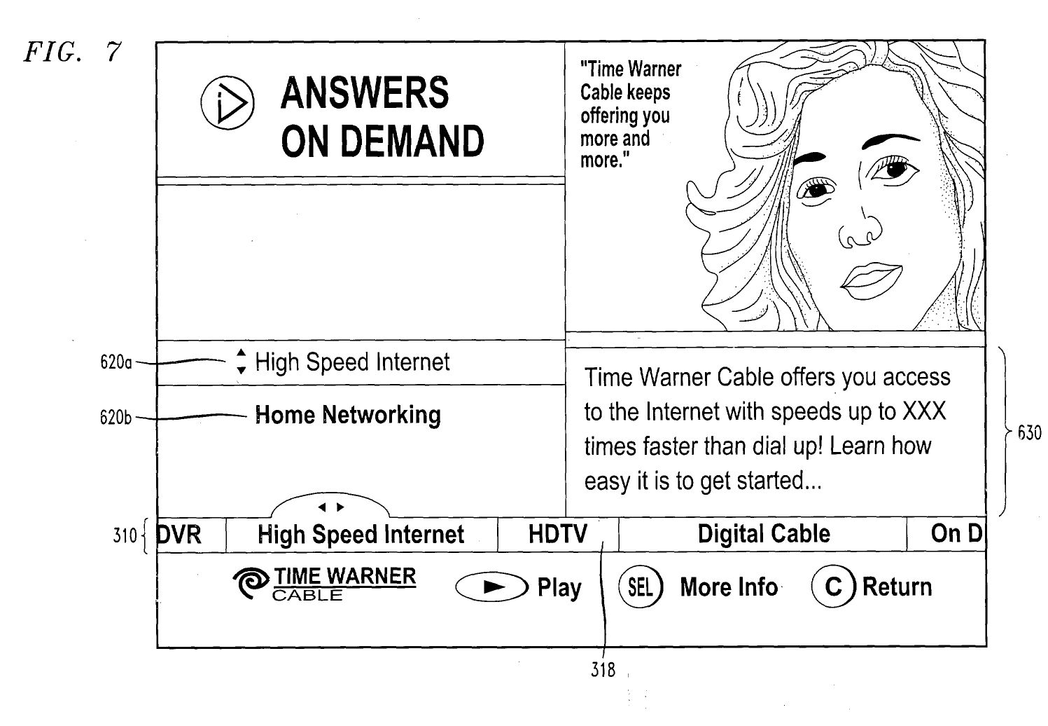

By selecting, say, “High Speed Internet” menu item 316 on service menu 310, the user is provided with another AOD GUI, which is illustrated in FIG. 7. This AOD GUI, referred to as a “High Speed Internet GUI,” relates to internet access using a cable network as opposed to, for example, a telephone network, for high speed connection.

As shown in FIG. 7, the High Speed Internet GUI provides topical options for which tutorial presentations are available. These topical options may include: High Speed Internet option 620a and Home Networking option 620b. In this instance, option 620a is highlighted, thereby providing a preview description (denoted 630) of a tutorial presentation having the highlighted topic—“Time Warner Cable offers you access to the Internet with speeds up to XXX times faster than dial up! . . . ” Upon learning description 630, the user may decide whether to select option 620a to obtain the related tutorial presentation.

In addition, in this instance a selection of Home Networking option 620b causes a provision of a tutorial presentation relating to the advantages of high speed Internet access through a home network, and the connectivity of such a home network with, e.g., home appliances.

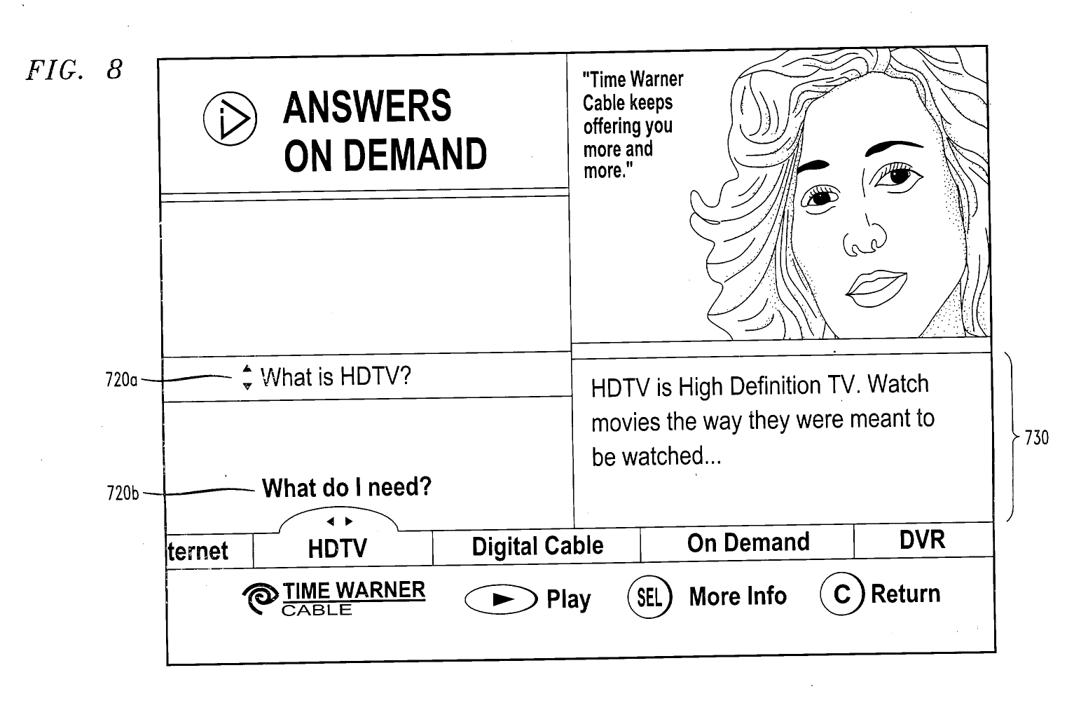

By selecting, say, “HDTV” menu item 318 on service menu 310, the user is provided with another AOD GUI, which is illustrated in FIG. 8. This AOD GUI, referred to as an “HDTV GUI,” relates to high definition TV (HDTV), as opposed to conventional analog TV.

As shown in FIG. 8, the HDTV GUI provides topical options for which tutorial presentations are available. These topical options may include: What is HDTV option 720a and What Do I Need option 620b. In this instance, option 720a is highlighted, thereby providing a preview description (denoted 730) of a tutorial presentation having the highlighted topic—“HDTV is high Definition TV. Watch movies the way they were meant to be watched . . . ” Upon learning description 730, the user may decide whether to select option 720a to obtain the related tutorial.

In addition, in this instance a selection of What Do I Need option 720b causes a provision of a tutorial presentation relating to the equipment required for accessing programming content with the HDTV standard, e.g., a HDTV-ready television set, HDTV tuner, etc.

It should be noted that additional tutorials may be provided, including those relating to establishing and changing personal identification numbers (PINs) to effectuate parental blocking and other security features, custom settings (such as timers, alarm clock, favorite channel, close captioning), short cuts respecting searching for available programming content, and the like.

The foregoing merely illustrates the principles of the invention. It will thus be appreciated that those skilled in the art will be able to devise numerous other arrangements which embody the principles of the invention and are thus within its spirit and scope.

For example, system 100 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A communications system for providing tutorial information through a two-way multichannel delivery network, the system comprising:
an interface for receiving from a terminal a request for tutorial information through the delivery network;
a server responsive to the request for transmitting a data stream containing selected tutorial information through the delivery network, the selected tutorial information including selectable options for tutorial presentations relating to a plurality of services available through the delivery network, the data stream being identified by an identifier; and
a controller for communicating the identifier to the terminal for receiving the data stream.

2. The system according to claim 1, wherein the delivery network includes a cable TV network.

3. The system according to claim 2, wherein the cable TV network includes a hybrid fiber coaxial (HFC) cable network.

4. The system according to claim 1, wherein the plurality of services include an on-demand service.

5. The system according to claim 4, wherein the on-demand service includes a video-on-demand (VOD) service.

6. The system according to claim 1, wherein the plurality of services include a digital cable service.

7. The system according to claim 1, wherein the plurality of services include an Internet service

8. The system according to claim 1, wherein at least one of the tutorial presentations is manipulatable to perform at least one of rewinding, pausing and fast-forwarding on the presentation.

9. The system according to claim 1, wherein at least one of the tutorial presentations includes a video presentation.

10. The system according to claim 1, wherein at least one of the tutorial presentations includes a slideshow presentation.

11. The system according to claim 1, wherein at least one of the tutorial presentations includes textual displays.

12. A method for use in a communications system for providing tutorial information through a two-way multichannel delivery network, the method comprising:
receiving from a terminal a request for tutorial information through the delivery network;
in response to the request, transmitting a data stream containing selected tutorial information through the delivery network, the selected tutorial information including selectable options for tutorial presentations relating to a plurality of services available through the delivery network, the data stream being identified by an identifier; and
communicating the identifier to the terminal for receiving the data stream.

13. The method according to claim 12, wherein the delivery network includes a cable TV network.

14. The method according to claim 13, wherein the cable TV network includes an HFC cable network.

15. The method according to claim 12, wherein the plurality of services include an on-demand service.

16. The method according to claim 15, wherein the on-demand service includes a VOD service.

17. The method according to claim 12, wherein the plurality of services include a digital cable service.

18. The method according to claim 12, wherein the plurality of services include an Internet service

19. The method according to claim 12, wherein at least one of the tutorial presentations is manipulatable to perform at least one of rewinding, pausing and fast-forwarding on the presentation.

20. The method according to claim 12, wherein at least one of the tutorial presentations includes a video presentation.

21. The method according to claim 12, wherein at least one of the tutorial presentations includes a slideshow presentation.

22. The method according to claim 12, wherein at least one of the tutorial presentations includes textual displays.

23. The method according to claim 12, further comprising downloading a selected one of the tutorial presentations to a recording device.

24. The method according to claim 12, further comprising printing content of a selected one of the tutorial presentations.

25. The method according to claim 12, wherein the request is initiated from the terminal in response to a user command.

26. The method according to claim 25, wherein the user command is issued by pressing a selected key on a remote control in communication with the terminal.

27. The method of claim 12, further comprising including in a tutorial presentation a selectable option to access a service related to the tutorial presentation.
